(19) United States
(12) Patent Application Publication
(10) Pub. No.: US 2026/0050742 A1
(43) Pub. Date: Feb. 19, 2026

(54) Ambient Sensor Representations for Contextual Inputs in Machine-Learned Sequence Processing Models

(71) Applicant: Google LLC, Mountain View, CA (US)

(72) Inventors: Octavio Ponce Madrigal, Mountain View, CA (US); Michal Matuszak, San Jose, CA (US)

(21) Appl. No.: 19/301,603

(22) Filed: Aug. 15, 2025

Related U.S. Application Data
(60) Provisional application No. 63/683,545, filed on Aug. 15, 2024.

(51) Int. Cl. G06F 40/284; G06F 16/3331; G06N 20/00

(52) U.S. Cl. CPC G06F 40/284; G06F 16/3331; G06N 20/00

(57) ABSTRACT

Aspects of the disclosed technology include machine-learning systems and methods for processing queries using contextual information that is derived from ambient sensors and/or auxiliary sensors. A machine-learning system is configured to tokenize ambient sensor data and/or auxiliary sensor data into representations for processing by a sequence processing model. The sensor data can be processed by the sequence processing model to provide contextual information that can aid in fulfilling the intent of a user query. The contextual information can assist the sequence processing model with reasoning and processing of the user query. Ambient sensor data contains little, if any, personally identifiable information, making it suitable for providing contextual information while maintaining user privacy. As such, embodiments of the present disclosure provide the ability for machine-learning systems to process sensor data with text-based user queries in order to provide contextualized query results.

### RELATED APPLICATIONS

This application is based upon and claims the right of priority to U.S. Provisional Application No. 63/683,545, filed on Aug. 15, 2024, the disclosure of which is hereby incorporated by reference herein in its entirety for all purposes.

### FIELD

The present disclosure relates generally to machine learning processes and machine-learned devices and systems. More particularly, the present disclosure relates to machine-learning systems for processing multimodal inputs.

### BACKGROUND

Search, assistant, and agent platforms have become ubiquitous in modern computing environments. Users frequently access search, assistant, and agent interfaces to help understand the world around them. Today, multimodal interfaces are readily available that enable users to provide text, image, audio, video, and other inputs as queries for processing by search and assistant platforms. Artificial intelligence systems increasingly include large foundational machine-learned models which have the capability to provide a wide range of new product experiences.

Recent advancement in sequence processing models, including the capabilities of large language models (LLMs) in reasoning, have led to increasing popularity in designing LLM based autonomous agents to fulfill human tasks using various tools. Understanding a user's intent, or simply the information that is sought by a user in response to an input can be difficult, particularly where the input lacks contextual information. For instance, an application may receive a text-based input with little or no other information to guide the application as to what a user's intent is. For instance, a user may request an assistant system to order coffee for everyone in a meeting. The system, however, may lack contextual information to fulfill the user intent, such as the number of people in the room.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by a computing system including one or more computing devices. The method includes obtaining sensor data generated by one or more ambient sensors, generating tokenized sensor data for at least one embedding space of a machine-learned sequence processing model, and generating, with the machine-learned sequence processing model, a contextualized query result based on at least one query and the tokenized sensor data.

Another example aspect of the present disclosure is directed to a system including one or more processors, and one or more computer-readable storage media that store instructions that, when executed by the one or more processors, cause the one or more processors to perform operations. The operations include obtaining sensor data generated by one or more ambient sensors, generating tokenized sensor data for at least one embedding space of a machine-learned sequence processing model, and generating, with the machine-learned sequence processing model, a contextualized query result based on at least one query and the tokenized sensor data.

Another example aspect of the present disclosure is directed to one or more non-transitory computer-readable storage media that store instructions that, when executed by one or more processors, cause the one or more processors to perform operations. The operations include obtaining sensor data generated by one or more ambient sensors, generating tokenized sensor data for at least one embedding space of a machine-learned sequence processing model, and generating, with the machine-learned sequence processing model, a contextualized query result based on at least one query and the tokenized sensor data.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a machine-learning system for processing queries using ambient sensor data for contextual information according to example implementations of aspects of the present disclosure;

FIG. 2 is a block diagram depicting an example computing environment including a machine-learning system for processing queries using ambient sensor data for contextual information according to example implementations of aspects of the present disclosure;

FIG. 3 is a flow chart diagram illustrating an example method for processing a query using ambient sensor data with a machine-learned model according to example implementations of aspects of the present disclosure;

FIG. 4 is a flow chart diagram illustrating an example method for processing a query using ambient sensor data with a machine-learned model according to example implementations of aspects of the present disclosure;

FIG. 5A is a block diagram depicting an example computing environment including a text large language model for processing queries using ambient sensor data for contextual information according to example implementations of aspects of the present disclosure;

FIG. 5B is a block diagram depicting an example computing environment including a multi-modal large language model for processing queries using ambient sensor data for contextual information according to example implementations of aspects of the present disclosure;

FIG. 6 is a block diagram depicting an example computing environment including a machine-learning system for processing queries using ambient sensor data for contextual information according to example implementations of aspects of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14A is a block diagram depicting an example computing system that performs query refinement processing for image-based queries according to example embodiments of the present disclosure; and

FIG. 14B is a block diagram depicting an example computing system that performs query refinement processing for image-based queries according to example embodiments of the present disclosure.

Reference numerals that are repeated across plural figures are intended to identify the same features in various implementations.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to computer-implemented systems and methods, and more particularly, to machine-learning systems and methods for processing queries using contextual information that is derived from ambient sensors. In accordance with example embodiments of the disclosed technology, a machine-learning system is provided that is configured to tokenize ambient sensor data into representations for processing by a sequence processing model. The system can generate tokenized sensor data such as sensor data tokens or token embeddings in at least one embedding space of the sequence processing model. The tokenized ambient sensor data can be processed by the sequence processing model to provide contextual information that can aid in fulfilling the intent of a user query. The contextual information can assist the sequence processing model with reasoning and processing of the user query. Ambient sensor data can contain little, if any, personally-identifiable information, making it suitable for providing contextual information while maintaining user privacy. Moreover, when tokenized, the ambient sensor data poses fewer privacy concerns. As such, embodiments of the present disclosure provide the ability for machine-learning systems to process ambient sensor data with text or audio-based user queries in order to provide contextualized query results. In example implementations, auxiliary sensors such as inertial measurement units, photoplethysmogram (PPG) sensors, magnetometers, barometers, etc. can be used with or in place of ambient sensors.

Smart devices such as phones, watches, smart screens, home assistants, etc. continue to increase in processing, memory, and power capacity. With the increase in compute abilities, these systems have progressed to include the ability to process user queries using machine-learned models. For example, many systems have the ability to take in information from a user and make recommendations, decisions, and/or perform system actions. In many instances, these systems lack the ability to gather and process contextual information to assist with processing user queries to provide an improved user experience. Consider an example of a user query that requests a machine-learning system to send a notification to go to sleep every night. Without contextual information, the system may send the user a notification at the same time every night to go to sleep. A better result may be achieved, however, if the system obtains contextual information such as the user's location, the user's movement, the user's breathing rate, etc. The system may determine that a notification should be sent later because a user is not at home, etc. As another example, consider a user query to an assistant system to “order coffee for everyone in the room.” Without contextual information, the system may be unable to determine the number of people in the room in order to fulfill the user query.

Recently, sequence processing models such as multimodal large language models (MMLLM) have been introduced that have the ability to process image data and/or audio data. The use of camera or image data, however, to determine contextual information may lead to privacy concerns. For example, users may be concerned with systems that enable cameras and microphones to collect data, particularly in so called always-on scenarios where the sensors collect data continuously or for extended periods of time. Furthermore, image data and audio data may not include spatial information which can be useful for determining contextual information.

In accordance with example embodiments of the present disclosure, a machine-learning system is provided that leverages ambient and/or auxiliary sensor data generated by one or more ambient and/or auxiliary sensors of a smart device. The ambient and/or auxiliary sensor data can be processed to determine or generate contextual information. A user query can be processed using the contextual information in order to personalize a user experience and/or to more accurately follow user instructions and query directives. The sensor data from one or more ambient and/or auxiliary sensors can be tokenized into tokens that are configured for processing by a sequence processing model such as a large language model (LLM). The user query and the sensor data tokens can be provided as one or more inputs to the sequence processing model. The sequence processing model can process the user query and the sensor data tokens to generate a contextualized query result. The contextualized query result can include a query result that is generated using contextual information derived from the sensor data. In this manner, the system can more accurately respond to the user query by incorporating the sensor data representations into the reasoning process to fulfill the user's intent.

Ambient sensors are often divided into categories including device to person (D2P) sensors and device to device (D2D) sensors. D2P sensors operate independently of other sensors to provide information with respect to a person to provide information about an environment. D2D sensors operate in conjunction with other sensors to make measurements and provide ambient information about an environment. Examples of D2P ambient sensors include ultrasonic sensors, radar-based sensors (e.g., millimeter wave sensors, ultrawideband sensors, etc.), optical proximity sensors, lidar sensors, and the like. Examples of D2D sensors include ultrasonic sensors, ultrawideband sensors, WiFi sensors, and bluetooth sensors (e.g., Hadam/channel sounding). Ambient sensors do not provide human audible sensor data or image data that can raise privacy concerns as with traditional camera and microphone sensors.

Ambient sensors can be leveraged to determine contextual information that can be provided as an input to a machine-learned model such as a large language model or other sequence processing model. The ambient sensor data can be processed to determine contextual information such as a user's relative location (e.g., a room or office), how many persons are in an environment, the motion of a user, ambient noise, user activity, and others. In some examples, additional sensor data such as sensor data from an inertial measurement unit (IMU) or magnetometer can be used in conjunction with the ambient sensor data. Because of the ambient nature of the data, unauthorized access to the ambient sensor data poses a smaller concern than traditional image and audio data. As such, the ambient sensor data and/or sensor data tokens can be stored and processed on-device without raising traditional privacy concerns.

According to example aspects of the present disclosure, ambient sensor data can be provided to a machine-learned sequence processing model to assist with processing user queries. In response to a user query, the system can input ambient sensor data to the sequence processing model in conjunction with the user query. The sequence processing model can be configured to process the user query with the ambient sensor data. By way of example, the sequence processing model can be configured to determine contextual information from the ambient sensor data and apply the contextual information to the user query during processing. The sequence processing model can reason using both the user query and the contextual information from the ambient sensor data. Continuing with the earlier examples, the system can provide radar data or optical proximity sensor data to the sequence processing model with a user query to “set a reminder to go to sleep every night.” The system may determine from contextual information that the user is not at home, and therefore, may delay sending the notification until the user is determined to be at home. Similarly, the system can provide radar or optical proximity data to the sequence processing model with a user query to “order coffee for everyone in the room.” The system can determine the number of people in the room based on the ambient sensor data to provide a query result that includes placing an order for coffee for the number of people determined to be in the room. Auxiliary sensor data can similarly be used.

According to example aspects of the present disclosure, a sequence processing model can be configured for processing different ambient and/or auxiliary sensing modalities. For example, a sequence processing model can be trained or pre-trained for particular modalities. In some examples, a pre-trained sequence processing model can be fine-tuned to process sensor data for the ambient sensing modalities. For instance, low-rank adaptation (LoRA) can be used to fine-tune a pre-trained large language model for processing ambient sensor data.

In accordance with example embodiments of the disclosed technology, a tokenization system is provided to generate tokenized sensor data. The tokenized sensor data can include sensor data tokens generated from the ambient and/or auxiliary sensor data. The sensor data tokens or embeddings of the sensor data tokens can be provided to the sequence processing model as input for processing a user query. For instance, a text query can be provided to the tokenization system to generate one or more text tokens for processing by the sequence processing model. Ambient sensor data can be provided to the tokenization system to generate one or more sensor data tokens for processing by the sequence processing model with the text tokens. In example embodiments, the text tokens and sensor data tokens can be aligned for sequential processing by the sequence processing model to provide a query result. The tokenization system can include one or more tokenizers that are configured to map sensor data inputs to discrete tokens for learning and processing by the sequence processing model. In this manner, the tokens can enable saving and processing of large amounts of sensor data. The sensor data tokens can include compressed sensor data that can be saved and processed in a compute efficient manner.

According to example aspects of the present disclosure, the tokenization system can include one or more tokenizers for tokenizing sensor data for different sensing modalities. In an example embodiment, the tokenization system can include a single tokenizer that is configured to generate sensor data tokens from different types of sensor data. In another example embodiment, the system can include different tokenizers for different types of sensors. For instance, a first tokenizer can be configured to generate tokens from the sensor data of a sensor of a first type (e.g., ultrasonic sensor) and a second tokenizer can be configured to generate tokens from the sensor data of a sensor of a second type (e.g., radar sensor). The tokenization system can generate segments, chunks, or other subsets of data from the sensor data. The tokenization system can generate tokens that embed and compress sensor data into representations capable of processing by the sequence processing model. In example embodiments, the tokenization system can include one or more machine-learned tokenization models that are configured to generate sensor data tokens as an output in response to raw sensor data as an input. In another example, a tokenizer can be configured to generate sensor data tokens in response to pre-processed sensor data. Each tokenizer of the tokenization system can include a machine-learned tokenization model that is configured to generate sensor data tokens in response to sensor data of one or more sensor modalities.

The tokenization system can be configured to generate sensor data tokens that are adapted for processing in a common embedding space of the sequence processing model. The tokenization system can provide the sensor data tokens directly to the sequence processing model in some examples. In other examples, the tokenization system can generate token embeddings by embedding the sensor data tokens into an embedding space of the sequence processing model. For example, the tokenization system can include one or more machine-learned embedding models such as a transformer or encoder configured to embed the sensor data tokens into the embedding space of the sequence processing model. In example embodiments, the embedding space of the sequence processing model can be a latent embedding space, a text embedding space, an image embedding space, and/or an audio embedding space.

In accordance with example embodiments of the present disclosure, a machine-learning sequence processing system can include a pre-processing system that is configured to pre-process raw sensor data before it is tokenized. Various types of pre-processors and pre-processing can be provided for different implementations. By way of example, ambient sensor data can be pre-processed to generate textual representations that can be tokenized into text tokens for processing by the sequence processing model. For example, raw radar or optical proximity data can be provided to a machine-learned classification model that is configured to generate one or more predictions or classifications of the raw sensor data. A prediction or classification can be represented as text which can be provided to a text tokenizer for generating one or more text tokens as input to the sequence processing model. For instance, raw sensor data can be provided as input to a machine-learned classification or prediction model that is configured to determine a number of people in a room based the sensor data. The model can output a text representation of the number of people in the room. In some examples, the pre-processor can format the text into an instruction or prompt such as, “the number of people in the room is 4.”

According to an example aspect of the present disclosure, sensor data pre-processing and tokenization can be performed in a compute-efficient manner by leveraging lower compute-capacity environments. Many mobile smart devices include a first computing environment that is configured for normal processing and memory functions and a second computing environment that is configured for less computationally expensive operations in order to save processing, memory, and battery life. The first computing environment may be referred to as a core computing environment and the second computing environment may be referred to as an always-on computing environment. An always-on computing environment is often provided for computing tasks that are performed anytime the device is powered-on. For example, when a device is not actively being used, an always-on computing environment can be used to sense movements or initial inputs that can trigger other applications and processing by the core computing environment.

In accordance with an example embodiment of the present disclosure, raw sensor data, pre-processed sensor data, sensor data tokens, and/or token embeddings can be generated using an always-on computing environment of a smart device. For example, sensor data from one or more ambient sensors and/or auxiliary sensors can be generated over a period of time and optionally stored in memory of the AOC environment. The sensor data can optionally be pre-processed by the AOC environment and optionally stored in the memory of the AOC environment. The raw sensor data and/or the pre-processed sensor data can be tokenized by the tokenization system and the sensor data tokens can be stored in the memory of the AOC environment. The sensor data tokens can optionally be embedded into token embeddings for the embedding space of the sequence processing model and stored in the memory of the AOC environment.

When a user query is received, the data from the always-on computing (AOC) environment can be transferred to the core computing environment for processing. When the system receives a user query, the ambient sensor data information can be transferred to the core computing environment for processing with the sequence processing model. For example, sensor data tokens for a time period corresponding to the user query can be transferred to the core computing environment. The sensor data tokens and the user query can be provided as an input to the sequence processing model. In this manner, the sensor data tokens can be generated and stored using compute-efficient resources and transferred to the core computing environment only as needed. As such, the machine-learning system can generate contextual information in a compute-efficient manner for aiding the sequence processing model in handling user queries.

Systems and methods in accordance with example embodiments of the present disclosure provide a number of technical effects and benefits. The systems and methods can include technologies for generating contextual information from ambient sensor data and/or auxiliary sensor data for processing with a user query by a machine-learned sequence processing model such as a large language model. Example aspects of the disclosed technology include a tokenization system that is configured to generate sensor data tokens and/or token embeddings that can be processed by a sequence processing model. In this manner, a sequence processing model can process text-based queries as well as contextual information derived from ambient sensor data. Moreover, a machine-learning system is described that is configured to generate contextual information from ambient sensor data so as to provide privacy-preserving implementations for determining contextual information.

According to example aspects of the disclosed technology, a computing efficient architecture is provided for processing ambient sensor data and/or auxiliary sensor data to generate tokens for processing by a sequence processing model. A first computing environment that consumes fewer computing resources and power can be used to generate sensor data tokens. When the system determines that the sensor data tokens should be used, the tokens can be transferred to a core computing environment for processing with the sequence processing model. In this manner, power can be conserved by utilizing lower power-consumption resources to generate tokens and then leveraging a higher compute environment to process the tokens with a sequence processing model.

With reference now to the Figures, example embodiments of the resent disclosure will be discussed in further detail.

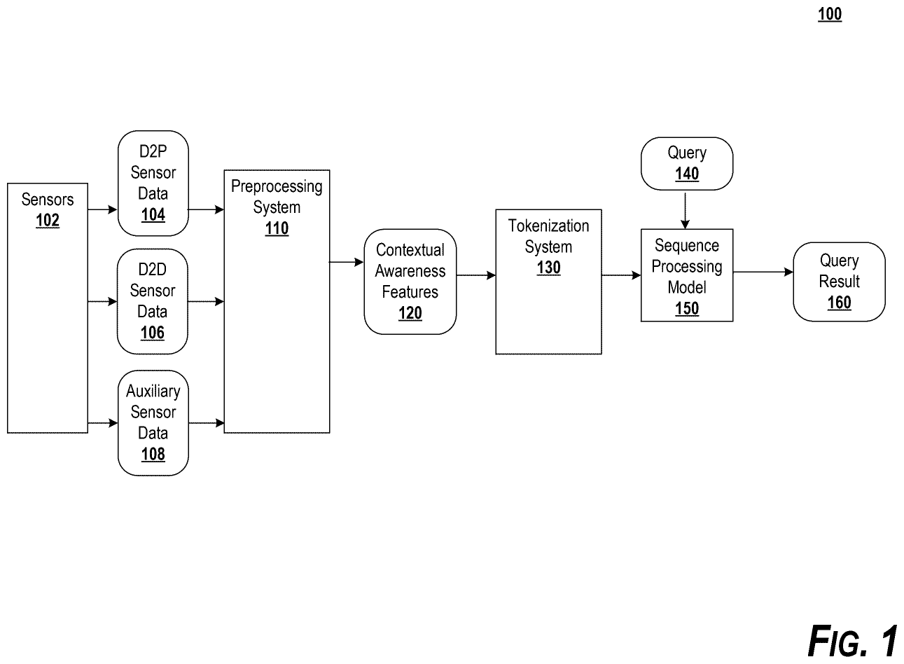

FIG. 1 depicts an example of a computing environment 100 including a machine-learning system according to example embodiments of the present disclosure. The components of computing environment 100 can be implemented by one or more computing devices, such as a client computing device (e.g., a smart device such as a smartphone, smartwatch, smart glasses, etc.). The computing system(s) implementing computing environment 100 can be connected to and communicate through one or more networks (not shown). Any number of computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a client computing device can implement a downstream search/assistant or other application. A client computing device can be any suitable device, including, but not limited to, a smartphone, a tablet, a laptop, a desktop computer, or any other computer device that is configured such that it can allow a user to access remote computing devices over a network. The client computing devices can include one or more processor(s), memory, and a display as described in more detail hereinafter. The client computing devices can execute one or more client applications such as a multi-modal search or assistant application, web browser, email application, chat application, video conferencing application, word processing application or the like.

In some implementations as shown in FIG. 1, the system can be used to generate a query result 160 in response to a query 140 using contextual information that is obtained from sensor data generated by one or more auxiliary sensors 102.

Sensors 102 can include ambient sensors and/or auxiliary sensors that are configured to generate ambient sensor data and/or auxiliary sensor data. Ambient sensors are often divided into categories including device to person (D2P) sensors and device to device (D2D) sensors. D2P sensors operate independently of other sensors to generate D2P sensor data 104 with respect to a person to provide information about an environment. D2D sensors operate in conjunction with other sensors to generate D2D sensor data 106 including measurements and ambient information about an environment. Examples of D2P ambient sensors include ultrasonic sensors, radar-based sensors (e.g., millimeter wave sensors, ultrawideband sensors, etc.), optical proximity sensors, lidar sensors, and the like. Examples of D2D sensors include ultrasonic sensors, ultrawideband sensors, WiFi sensors, and bluetooth sensors (e.g., Hadam/channel sounding). Ambient sensors do not provide human audible sensor data or image data that may raise privacy concerns as with traditional camera and microphone sensors. In some examples, synchronization can be performed for sensor fusion of the sensor data. Examples of auxiliary sensors include inertial measurement units, photoplethysmogram (PPG) sensors, magnetometers, barometers, etc.

Ambient sensor data 104 and 106 and auxiliary sensor data 108 can optionally be pre-processed by a pre-processing system 110. Contextual awareness features can be generated by the preprocessing system in example embodiments. In some examples, a machine-learned model of the preprocessing system, such as a feature generation model, can receive the sensor data and generate contextual awareness features 120. In some examples, a feature generation model can include a classification model, a prediction model, and/or a transformer. By way of example, a feature generation model can receive sensor data and generate textual features as an output. In some examples, synchronization can be performed for sensor fusion of the sensor data before pre-processing. Contextual awareness features can include, by way of example, range doppler information, interferogram data, time series of user/device position, ambient interference, etc. The contextual awareness features can include information about the context around and/or near to a user (e.g., the number of people in a room, whether lights are on/off, etc.). The contextual awareness features can include information about the context of a user directly, such as a user's heart rate, respiration rate, motion, etc.

Various types of pre-processors and pre-processing can be provided for different implementations. By way of example, ambient sensor data can be pre-processed to generate textual representations that can be tokenized into text tokens for processing by the sequence processing model. For example, raw radar or optical proximity data can be provided to a machine-learned classification model that is configured to generate one or more predictions or classifications of the raw sensor data. A prediction or classification can be represented as text which can be provided to a text tokenizer for generating one or more text tokens as input to the sequence processing model. For instance, raw sensor data can be provided as input to a machine-learned classification or prediction model that is configured to determine a number of people in a room based the sensor data. The model can output a text representation of the number of people in the room. In some examples, the pre-processor can format the text into an instruction or prompt such as, “the number of people in the room is 4.”

The contextual awareness features and/or the sensor data can be provided to a tokenization system 130. Tokenization system 130 can generate one or more sensor data tokens from the ambient sensor data and provide the tokens to a machine-learned sequence processing model 150. In some examples, the machine-learning system can embed the sensor data tokens into an embedding space for sequence processing model 150. An embedding model can compress and represent the tokens as token embeddings. In some examples, the embeddings can include contextual tokens. The tokenization system can be configured to generate sensor data tokens that are adapted for processing in a common embedding space of the sequence processing model. The tokenization system can provide the sensor data tokens directly to the sequence processing model in some examples. In other examples, the tokenization system can generate token embeddings by embedding the sensor data tokens into an embedding space of the sequence processing model. For example, the tokenization system can include one or more machine-learned embedding models such as a transformer or encoder configured to embed the sensor data tokens into the embedding space of the sequence processing model. In example embodiments, the embedding space of the sequence processing model can be a latent embedding space, a text embedding space, an image embedding space, and/or an audio embedding space.

According to an example aspect of the disclosure, a machine-learned model such as a tokenization model can generate sensor data tokens. The tokenization model or an embedding model can generate token embeddings from sensor data. The tokens or token embeddings can contain contextual data such as a user's relative location (e.g., a room or office), how many persons are in an environment, the motion of a user, ambient noise, user activity, etc. The tokenization model and or the embedding model can extract contextual features from the sensor data which can be compressed for representation as tokens and/or embeddings.

In some examples, tokenization system 130 can include one or more transformer models to implement one or more tokenizers. The model can include one or more embedding layers configured to receive features or sensor data and generate tokenized sensor data such as sensor data tokens. The embedding layers can include radar embedding layer(s) (e.g., a transformer) and text embedding layer(s) (e.g., a word embedding layer). The model can include a transformer encoder to generate radar, lidar, optical, ultrasonic, and/or other sensor modality representations.

The tokenization system can include one or more tokenizers for tokenizing sensor data for different sensing modalities. In an example embodiment, the tokenization system can include a single tokenizer that is configured to generate sensor data tokens from different types of sensors. In another example embodiment, the system can include different tokenizers for different types of sensors. For instance, a first tokenizer can be configured to generate tokens from the sensor data of a sensor of a first type (e.g., ultrasonic sensor) and a second tokenizer can be configured to generate tokens from the sensor data of a sensor of a second type (e.g., radar sensor). The tokenization system can generate segments, chunks, or other subsets of data from the sensor data. The tokenization system can generate tokens that embed and compress sensor data into representations capable of processing by the sequence processing model. In example embodiments, the tokenization system can include one or more machine-learned tokenization models that are configured to generate sensor data tokens as an output in response to raw sensor data as an input. In another example, a tokenizer can be configured to generate sensor data tokens in response to pre-processed sensor data. Each tokenizer of the tokenization system can include a machine-learned tokenization model that is configured to generate sensor data tokens in response to sensor data of one or more sensor modalities.

Sequence processing model can 150 receive the sensor data tokens and/or the token embeddings. Sequence processing model 150 can process the tokenized sensor data to generate a query result 160 in response to query 140.

Query 140 can be received via a user interface of an assistant, agent, or search system in example embodiments. Query 140 can include text data representing a text input in some examples. Query 140 can include a multimodal input including text data, image data, audio data, and the like. Text can include one or more text fragments in example embodiments.

The tokens and/or embeddings can be provided to the sequence processing model to bias or condition the model towards the contextual data when responding to the query. The embeddings can be provided as tokens to the model to prompt the model in association with a task instruction. For example, the model can process an input including contextual tokens from the embedding model.

In some examples, one or more inputs including tokens or token embeddings based on the query 140 and the ambient sensor data are provided to sequence processing model 150. An input can include tokens generated by the tokenization system. In example embodiments, an input can include prompt tokens. Prompt tokens can be fixed prompt tokens based on a task to be performed in some examples. Prompt tokens are optional. A prompt input can include a combination of tokenized sensor data and a tokenized query in some examples. In some examples, a prompt input is a soft-prompt. Sequence processing model 150 can process the query tokens using the sensor data tokens to provide contextual information to provide an output personalized for the user based on ambient sensor data.

A sequence processing model 150 can be configured for processing different ambient sensing modalities. For example, a sequence processing model can be trained or pre-trained for particular modalities. In some examples, a pre-trained sequence processing model can be fine-tuned to process sensor data for the ambient sensing modalities. For instance, low-rank adaptation (LoRA) can be used to fine-tune a pre-trained large language model for processing ambient sensor data. A sequence processing model 150 in accordance with example embodiments can include a large language model or a multimodal model such as a machine-learned multimodal large language model. A large image-language model can include 10B parameters or more in some examples. In other examples, a sequence processing model can include less than 10B parameters (e.g., 1B parameters). In yet another example, the sequence processing model can include a machine-learned text-to-image model, a machine-learned text-to-video model, a machine-learned text-to-audio model, a machine-learned multi-modal model, or any other machine-learned model configured to provide generative content in response to a user query. The generative content generated by sequence processing models can include computer-executable code data, text data, image data, video data, audio data, or other types of generative content. The model can be trained to process input data to generate output data. The input data can include text data, image data, audio data, latent encoding data, and/or other input data, which may include multimodal data. The output data can include computer-executable code data, text data, image data, audio data, latent encoding data, and/or other input data.

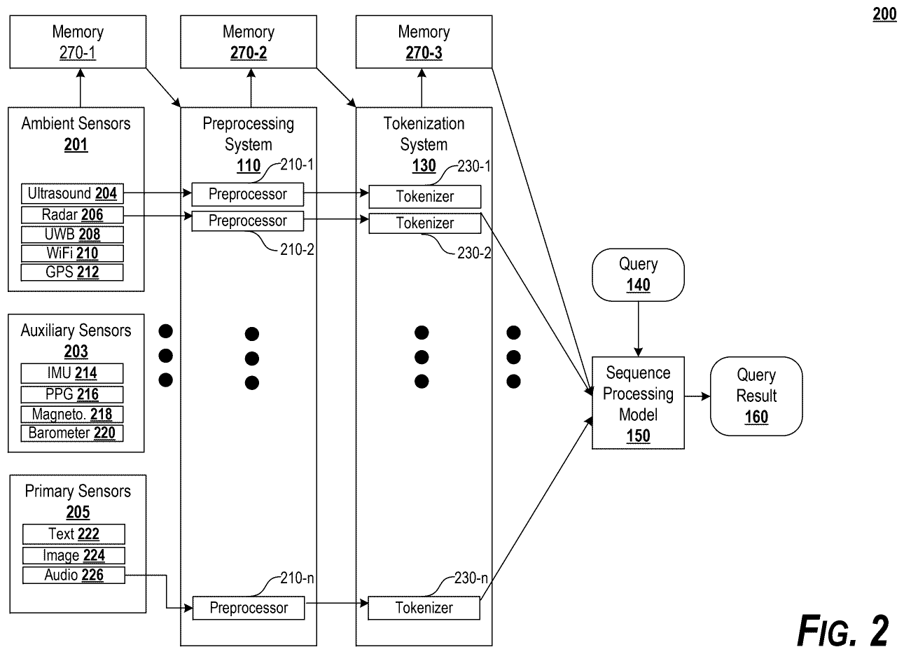

FIG. 2 depicts an example of a computing environment 200 including a machine-learning system according to example embodiments of the present disclosure. Computing environment 200 depicts additional details of a machine-learning system including a sequence processing model 150 that is configured to obtain a query and tokenized ambient sensor data to generate a contextualized query result 160.

Computing environment 200 includes ambient sensors 201, auxiliary sensors 203, and primary sensors 205. In example implementations, a computing environment may only include ambient sensors 201 or auxiliary sensors 203. Computing environment 200 includes an optional preprocessing system 110, and a tokenization system 130 configured to generate tokenized sensor data for processing by sequence processing model 150. In environment 200, ambient sensors 201 include an ultrasonic sensor 204 a radar sensor 206, an ultrawideband sensor 208, a WiFi sensor 210 and GPS sensor 212. Additional types of ambient sensors include proximity sensors, light sensors, etc. It is noted that fewer or additional auxiliary sensors may be included in example embodiments. For example, one or more laser-based optical sensors can be used in example embodiments. Ambient sensors 201 can include any sensor configured to generate ambient sensor data. Auxiliary sensors 203 can include an inertial measurement unit (214), a photoplethysmogram (PPG) sensor 216, magnetometer 218, barometer 220, etc. Computing environment also includes primary sensors 205 including a text sensor 222, image sensor 224, and audio sensor 226. Primary sensors 205 are optional and can include fewer or additional sensors in example embodiments. Computing environment includes one or more memories such as memory 270-1, memory 270-2, and memory 270-3. Auxiliary sensors 102 and/or primary sensors 203 can be configured to provide sensor data to memory 270-1 for storage. In some examples, synchronization for sensor fusion of sensor data of different modalities can be performed.

Pre-processing system 110 includes a plurality of preprocessors 210-1, 210-2, . . . , 210-n, including an individual preprocessor for each sensor. Preprocessing system 110 is optional. Further, a preprocessing system can include fewer or additional preprocessors. For example, a single preprocessor may be included to process all of these sensor modalities in other examples. The pre-processed sensor data from the preprocessors or the raw sensor data can be provided to tokenization system 130. The pre-processed sensor data can optionally be stored in memory 270-2. In some examples, synchronization for sensor fusion of sensor data of different modalities can be performed.

Various types of pre-processors and pre-processing can be provided for different implementations. By way of example, ambient sensor data can be pre-processed to generate textual representations that can be tokenized into text tokens for processing by the sequence processing model. For example, pre-processor 210-1 can include one or more machine-learned models. For instance, raw radar or optical proximity data can be provided to a machine-learned classification model that is configured to generate one or more predictions or classifications of the raw sensor data. A prediction or classification can be represented as text which can be provided to a text tokenizer for generating one or more text tokens as input to the sequence processing model. For instance, raw sensor data can be provided as input to a machine-learned classification or prediction model that is configured to determine a number of people in a room based the sensor data. The model can output a text representation of the number of people in the room. In some examples, the pre-processor can format the text into an instruction or prompt such as, “the number of people in the room is 4.”

Tokenization system 130 includes a plurality of tokenizers 230-1, 230-2, . . . 230-n, including an individual tokenizer for each sensor. Tokenization system 130 can include fewer or additional tokenizers. For example, a single multimodal tokenizer 230 may be included that is configured to tokenize data for every sensor modality in some examples. Tokenizers 230 can be configured to generate sensor data tokens from the raw sensor data or the preprocessed sensor data from one or more sensors. Tokenization system 130 can optionally be configured to generate token embeddings by embedding the sensor data tokens in a target embedding space for sequence processing model 150. The tokenized sensor data including sensor data tokens and/or token embeddings can be provided to sequence processing model 150. The tokenized sensor data can optionally be stored in memory 270-3. In some examples where the tokenized sensor data is stored in memory 270-3, a direct link between tokenization system 130 and sequence processing model 150 may not be necessary.

Sequence processing model can 150 receive the sensor data tokens and/or the token embeddings. Sequence processing model 150 can process the tokenized sensor data to generate a query result 160 in response to query 140.

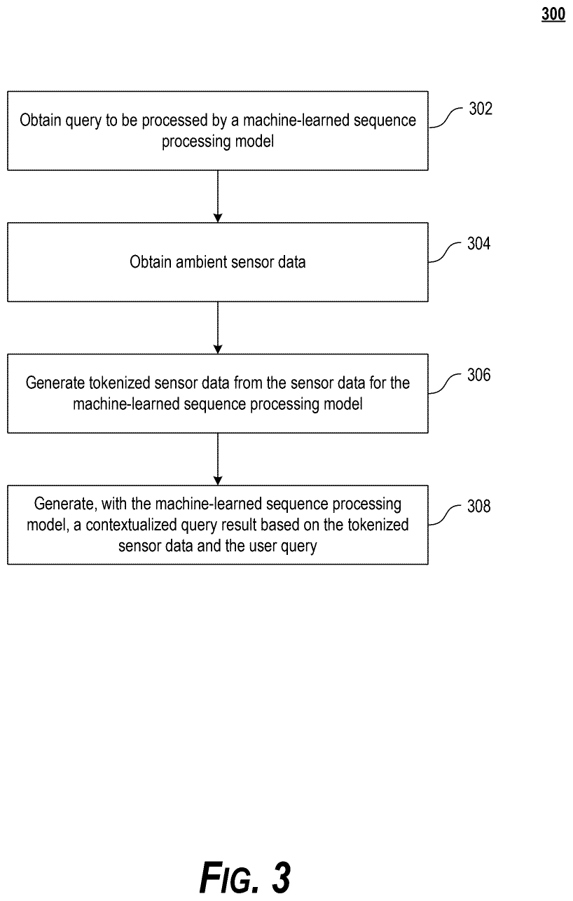

FIG. 3 is a flowchart diagram depicting an example method 300 for query processing by a system utilizing contextual information obtained from sensor data of one or more ambient sensors to generate query results according to example embodiments of the present disclosure. One or more portion(s) of example method 300 and the other methods described herein can be implemented by a computing system that includes one or more computing devices, such as, for example, computing systems described with reference to FIG. 1 and FIG. 2 and hereinafter. By way of example, one or more portions of example method 300 can be performed by a machine-learning system. Each respective portion of the example methods can be performed by any (or any combination) of one or more computing devices. Moreover, one or more portion(s) of the example method 300 can be implemented on the hardware components of the device(s) described herein, for example, to generate query results in response to user queries. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and are not meant to be limiting. One or more portions of the example methods can be performed additionally, or alternatively, by other systems.

At 302, method 300 can include obtaining a query to be processed by a machine-learned sequence processing model. An input can be received as text data and can be received with or as part of a user query generated by a client computing device. The user query can additionally include text data, audio data, video data, other image data, multimodal data, and various combinations thereof.

At 304, method 300 can include obtaining ambient sensor data. Ambient sensors including D2P sensors and device to device D2D sensors can be used to generate ambient sensor data. Example ambient sensors include, but are not limited to, ultrasonic sensors, radar-based sensors (e.g., millimeter wave sensors, ultrawideband sensors, etc.), optical proximity sensors, lidar sensors, WiFi sensors, and bluetooth sensors. Ambient sensors do not provide human audible sensor data or image data that may raise privacy concerns as with traditional camera and microphone sensors. Although method 300 is described with respect to ambient sensor data, the method can similarly be performed with auxiliary sensor data. At 306, method 300 can include generating tokenized sensor data from the ambient sensor data. For instance, a text query can be provided to the tokenization system to generate one or more text tokens for processing by the sequence processing model. Ambient sensor data can be provided to the tokenization system to generate one or more sensor data tokens for processing by the sequence processing model with the text tokens. In example embodiments, the text tokens and sensor data tokens can be aligned for sequential processing by the sequence processing model to provide a query result. The tokenization system can include one or more tokenizers that are configured to map sensor data inputs to discrete tokens for learning and processing by the sequence processing model. In this manner, the tokens can enable saving and processing of large amounts of sensor data. The sensor data tokens can include compressed sensor data that can be saved and processed in a compute efficient manner.

At 308, method 300 can include generating, with the machine-learned sequence processing model, a contextualized query result based on the tokenized sensor data and the user query. The sequence processing model can be configured to process the user query with the ambient sensor data. By way of example, the sequence processing model can be configured to determine contextual information from the ambient sensor data and apply the contextual information to the user query during processing. The sequence processing model can reason using both the user query and the contextual information from the ambient sensor data. Continuing with the earlier examples, the system can provide radar data or optical proximity sensor data to the sequence processing model with a user query to “set a reminder to go to sleep every night.” The system may determine from contextual information that the user is not at home, and therefore, may delay sending the notification until the user is determined to be at home. Similarly, the system can provide radar or optical proximity data to the sequence processing model with a user query to “order coffee for everyone in the room.” The system can determine the number of people in the room based on the ambient sensor data to provide a query result that includes placing an order for coffee for the number of people determined to be in the room.

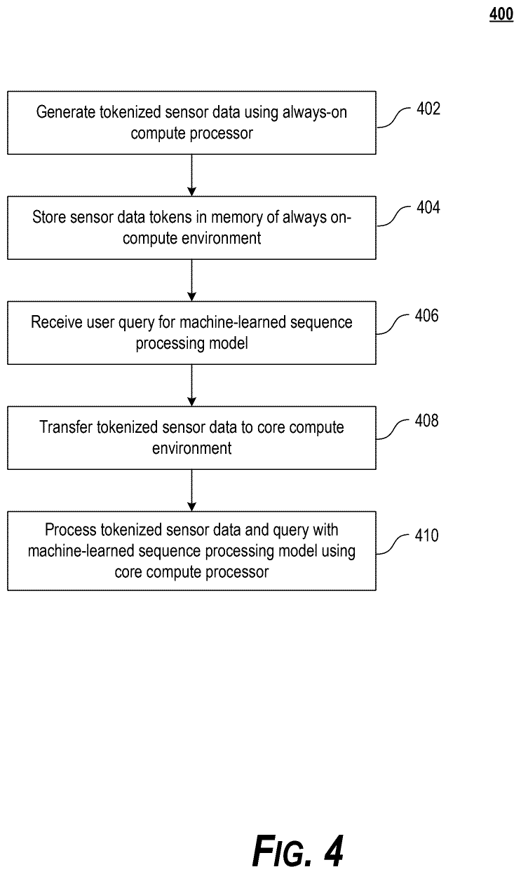

FIG. 4 is a flowchart diagram depicting an example method 400 for query processing by a system utilizing contextual information obtained from sensor data of one or more ambient sensors to generate query results according to example embodiments of the present disclosure. According to an example aspect of the present disclosure, sensor data pre-processing and tokenization can be performed in a compute-efficient manner by leveraging lower compute-capacity environments.

When a user query is received, the data from the always-on computing (AOC) environment can be transferred to the core computing environment for processing. For example, sensor data from one or more ambient sensors can be generated over a period of time and optionally stored in memory of the AOC environment. The sensor data can optionally be pre-processed by the AOC environment and optionally stored in the memory of the AOC environment. The raw sensor data and/or the pre-processed sensor data can be tokenized by the tokenization system and the sensor data tokens can be stored in the memory of the AOC environment. The sensor data tokens can optionally be embedded into token embeddings for the embedding space of the sequence processing model and stored in the memory of the AOC environment.

At 402, method 400 can include generating tokenized sensor data with an always-on compute processor of an always-on compute environment of a computing device (e.g., a smart device). In accordance with an example embodiment of the present disclosure, raw sensor data, pre-processed sensor data, sensor data tokens, and/or token embeddings can be generated using an always-on computing environment of a smart device. For example, sensor data from one or more ambient sensors can be generated over a period of time using an always-on processor. The sensor data can optionally be pre-processed by the AOC environment. The raw sensor data and/or the pre-processed sensor data can be tokenized by the tokenization system using the always-on processor. The sensor data tokens can optionally be embedded into token embeddings for the embedding space of the sequence processing model using the AOC processor.

At 404, method 400 can include storing the tokenized sensor data in a memory of the always-on compute environment of the computing device. The sensor data from the ambient sensors can optionally be stored in the memory of the AOC environment. The pre-processed sensor data can also optionally be stored in the memory of the AOC environment.

At 406, method 400 can include receiving a user query at the computing device.

At 408, method 400 can include transferring the tokenized sensor data from the memory of the always-on computing environment to the core computing environment of the computing device. When a user query is received, the data from the always-on computing (AOC) environment can be transferred to the core computing environment for processing. For example, sensor data tokens for a time period corresponding to the user query can be transferred to the core computing environment. When the system receives a user query, the ambient sensor data information can be transferred to the core computing environment for processing with the sequence processing model. For example, sensor data tokens for a time period corresponding to the user query can be transferred to the core computing environment. The sensor data tokens and the user query can be provided as an input to the sequence processing model.

At 410, method 400 can include processing the tokenized sensor data and the query with a core processor of the core computing environment of the core computing environment of the computing device. The sensor data tokens and the user query can be provided as an input to the sequence processing model. In this manner, the sensor data tokens can be generated and stored using compute-efficient resources and transferred to the core computing environment only as needed. As such, the machine-learning system can generate contextual information in a compute-efficient manner for aiding the sequence processing model in handling user queries.

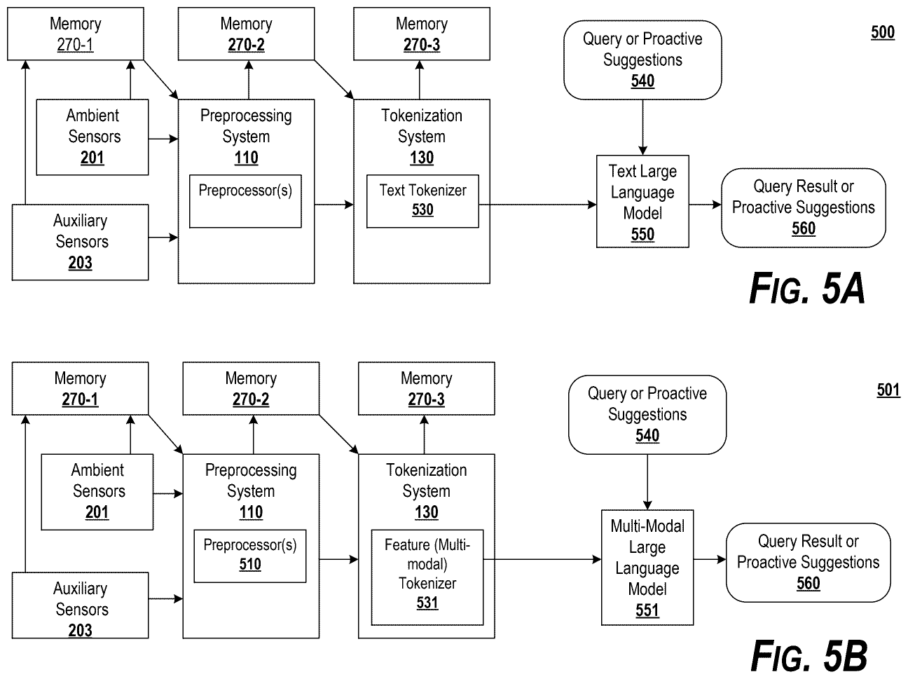

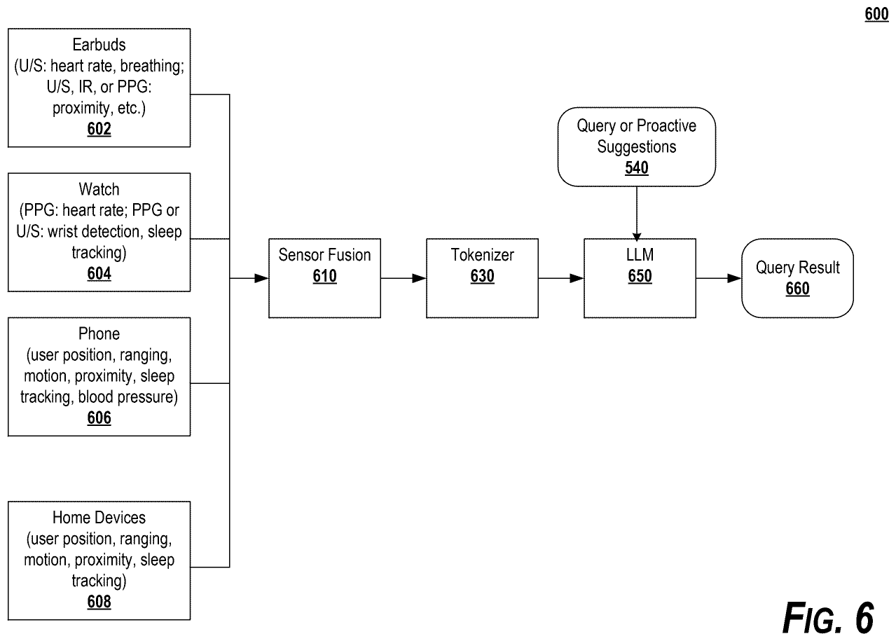

FIG. 5A is a block diagram depicting an example computing environment 500 including a machine-learning system for processing queries using ambient sensor data for contextual information according to example implementations of aspects of the present disclosure. FIG. 5A depicts an example of an implementation that includes a text large language model 550 that is configured to process tokenized ambient sensor data to generate a query result or proactive suggestions in response to a query or proactive suggestion input.

Computing environment 500 includes ambient sensors 201, auxiliary sensors 203, an optional preprocessing system 110, and a tokenization system 130 configured to generate tokenized sensor data for processing by text large language model 550. Ambient sensors 201 can include any of the ambient sensors described herein such as ultrasonic sensors, radar sensors, ultrawideband sensors, ultrasound sensors, etc. Auxiliary sensors 203 can include any of the auxiliary sensors described herein such as IMU's, PPG's, etc. In other examples, computing environment may only include ambient sensors or auxiliary sensors.

Pre-processing system 110 includes a single preprocessor 510 configured to process sensor data from multiple sensors. The pre-processed sensor data from the preprocessors or the raw sensor data can be provided to tokenization system 130. The pre-processed sensor data can optionally be stored in memory 270-2. In some examples, synchronization for sensor fusion of sensor data of different modalities can be performed.

Tokenization system 130 includes a single text tokenizer configured to generate text tokens from the sensor data of different types of sensors. In other examples, a plurality of tokenizers can be included, such as an individual tokenizer for each sensor. Tokenizer 530 can be configured to generate text tokens from the raw sensor data or the preprocessed sensor data from one or more sensors. The tokenized sensor data including text tokens and/or token embeddings can be provided to sequence processing model 150. The tokenized sensor data can optionally be stored in memory 270-3. In some examples where the tokenized sensor data is stored in memory 270-3, a direct link between tokenization system 130 and sequence processing model 150 may not be necessary.

Text large language model 550 can process the tokenized sensor data to generate a query result or proactive suggestions 560 in response to query or proactive suggestions 540.

FIG. 5B is a block diagram depicting an example computing environment 501 including a machine-learning system for processing queries using ambient sensor data for contextual information according to example implementations of aspects of the present disclosure. FIG. 5B depicts an example of an implementation that includes a multi-modal large language model 551 that is configured to process tokenized ambient sensor data and/or auxiliary data to generate a query result or proactive suggestions in response to a query or proactive suggestion input.

Computing environment 501 is configured in the same manner as FIG. 5A and includes ambient sensors 201, auxiliary sensors 203, an optional preprocessing system 110, and a tokenization system 130 configured to generate tokenized sensor data for processing by text large language model 550.

Tokenization system 130 includes a single feature tokenizer configured to generate feature tokens from the sensor data of different types of sensors. In other examples, a plurality of tokenizers can be included, such as an individual tokenizer for each sensor. Tokenizer 531 can be configured to generate feature tokens from the raw sensor data or the preprocessed sensor data from one or more sensors. Tokenizer 531 can be configured as a multi-modal tokenizer to generate tokenized sensor data such as feature tokens from different sensor types. The tokenized sensor data including feature tokens and/or token embeddings can be provided to multi-modal large language model 551. The tokenized sensor data can optionally be stored in memory 270-3. In some examples where the tokenized sensor data is stored in memory 270-3, a direct link between tokenization system 130 and multi-modal large language model 551 may not be necessary.

Multi-modal large language model 551 can process the tokenized sensor data to generate a query result or proactive suggestions 560 in response to query or proactive suggestions 540.

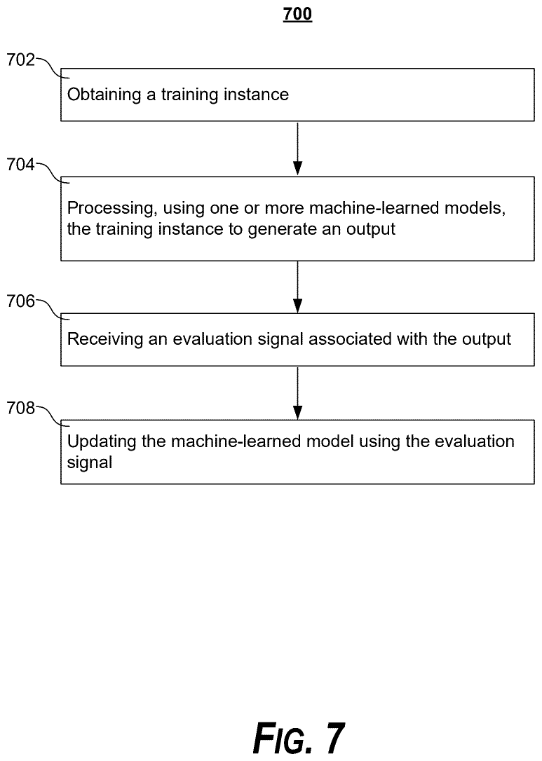

FIG. 6 is a block diagram depicting an example computing environment 600 including a machine-learning system for processing queries using ambient sensor data for contextual information according to example implementations of aspects of the present disclosure. FIG. 6 depicts an example of a multi-device input agent application. In the example of FIG. 6, multiple smart devices including earbuds 602, watch 604, phone 606, and home devices 608 are depicted. It is noted that fewer, additional, or alternate devices may be included in different implementations. The devices can provide sensor data simultaneously although this is not required. The devices can provide sensor data opportunistically in other examples. By way of example, the input agent can be configured in a smart home environment to learn user intent at home, as a user health agent to provide advice and summarization of health, and/or as a user intent agent to predict what a user may do.

Earbuds 602 can include one or more ultrasound (U/S) sensors that are configured to generate sensor data that can be used to determine heart rate, breathing rate. Earbuds 602 can include one or more ultrasound (U/S) sensors, one or more infrared sensors, and/or one or more photoplethysmography (PPG) sensors that are configured to generate sensor data that can be used to determine proximity and/or other information. Watch 6014 can include one or more PPG sensors that are configured to generate sensor data that can be used to determine heart rate. Watch 604 can include one or more U/S sensors and/or one or more PPG sensors that are configured to generate sensor data that can be used to determine wrist detection and sleep tracking. Phone 606 can include one or more sensors that are configured to generate sensor data that can be used to determine user position, ranging, motion, proximity, sleep tracking, blood pressure, etc. Home devices 608 can include one or more sensors that are configured to generate sensor data that can be used to determine user position, ranging, motion, proximity, sleep tracking, etc. It is noted that the types of sensors and sensing can vary by implementation.

The sensor data can optionally be provided to a pre-processing system to perform sensor fusion 610. The fused or raw sensor data can then be provided to a tokenizer 630 that is configured to generate tokenized sensor data which can be input to large language model 650. LLM 650 can include a text LLM or a multi-modal LLM. LLM 650 can process a query or proactive suggestion 640 to generate a query result or proactive suggestion 660.

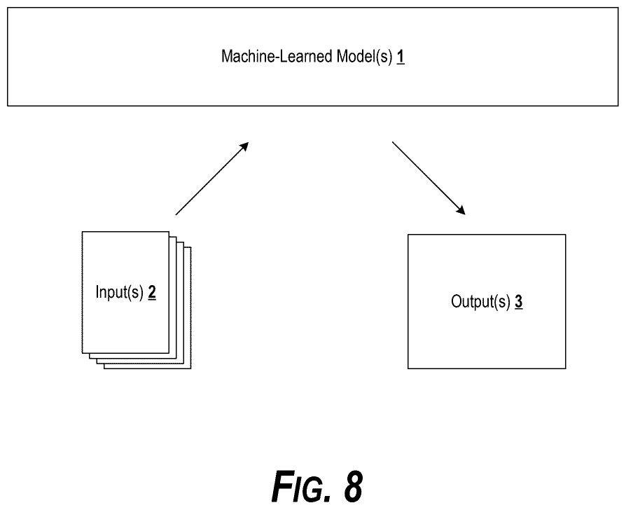

FIG. 7 depicts a flowchart of a method 700 for training one or more machine-learned models according to aspects of the present disclosure. For instance, an example machine-learned model can include a cross-modal adapter, text embedding model, image embedding model, text projection model, or image projection model. The example method can be used to train a machine-learned system including multiple machine-learned models or layers. The example method can be used for end-to-end training in which training data is processed through multiple models to determine an output.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

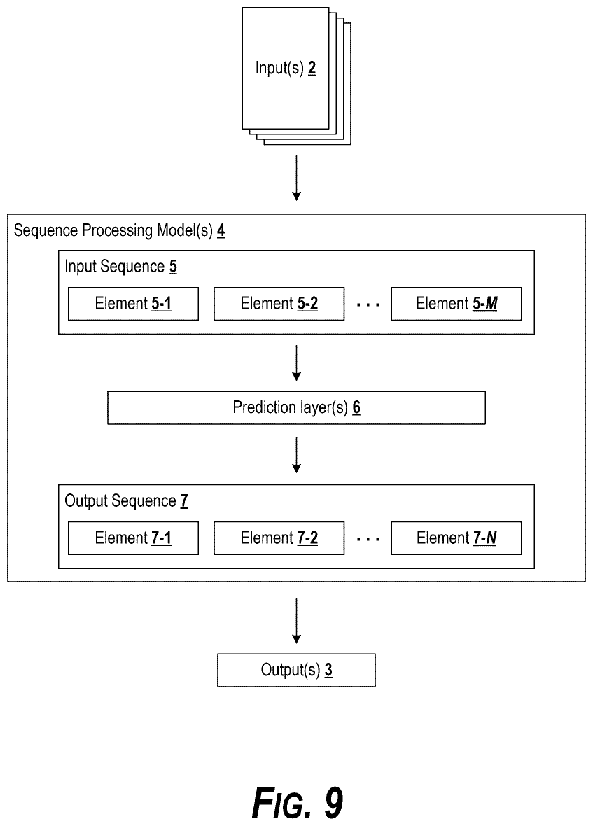

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

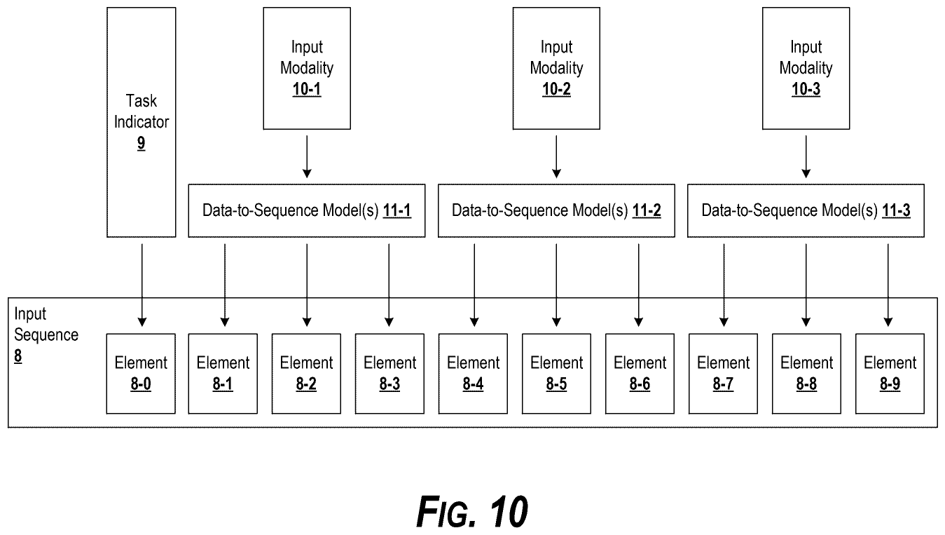

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

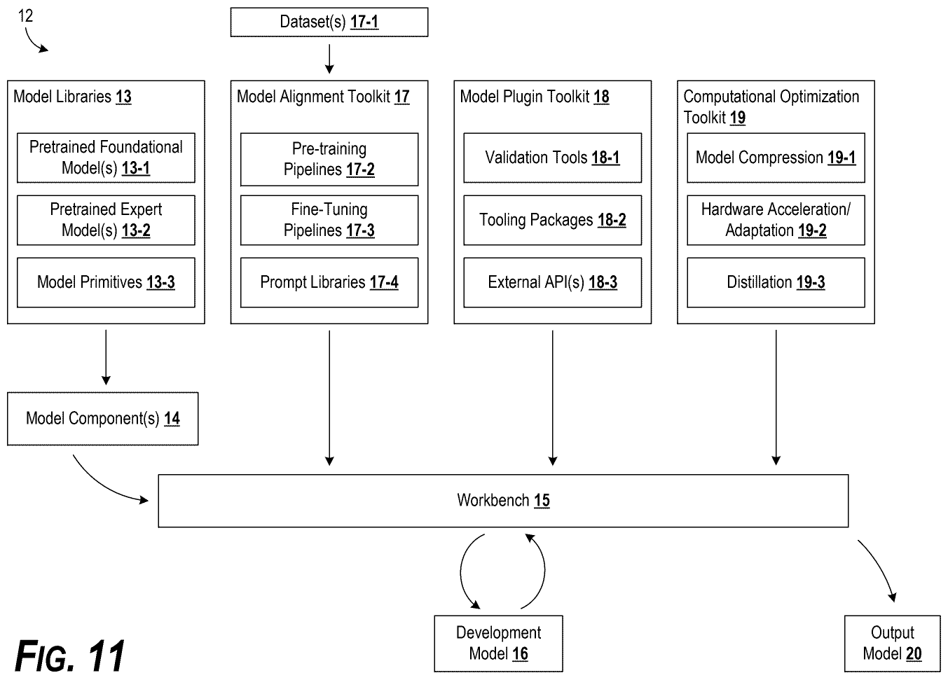

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

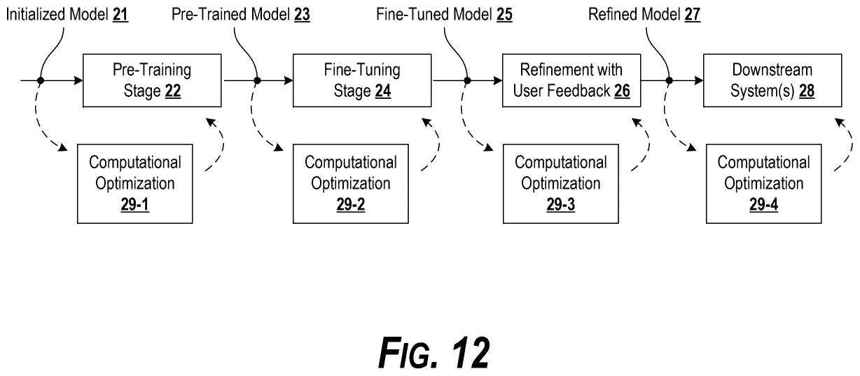

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

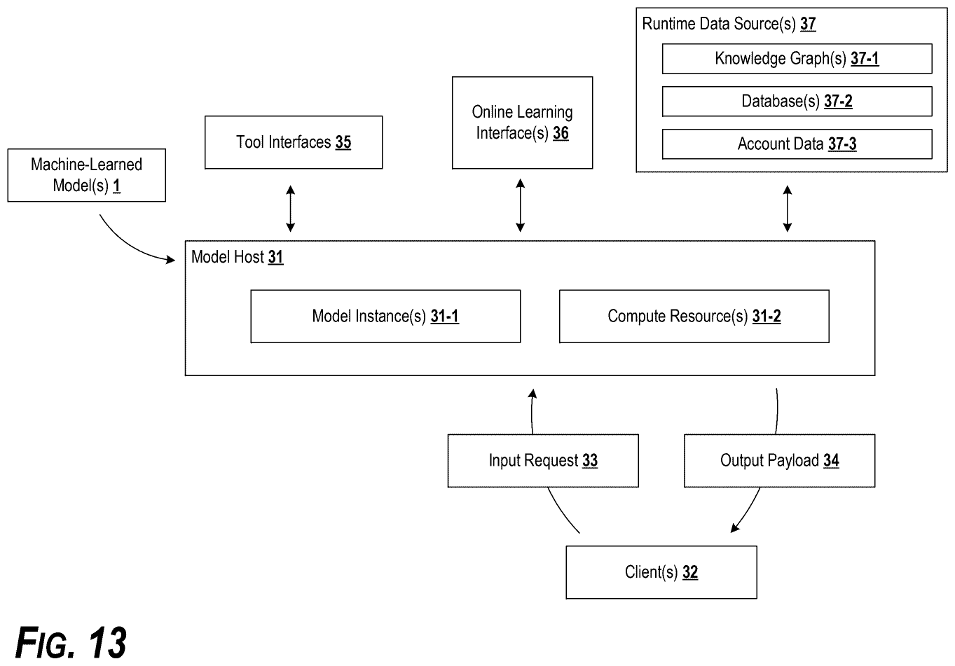

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

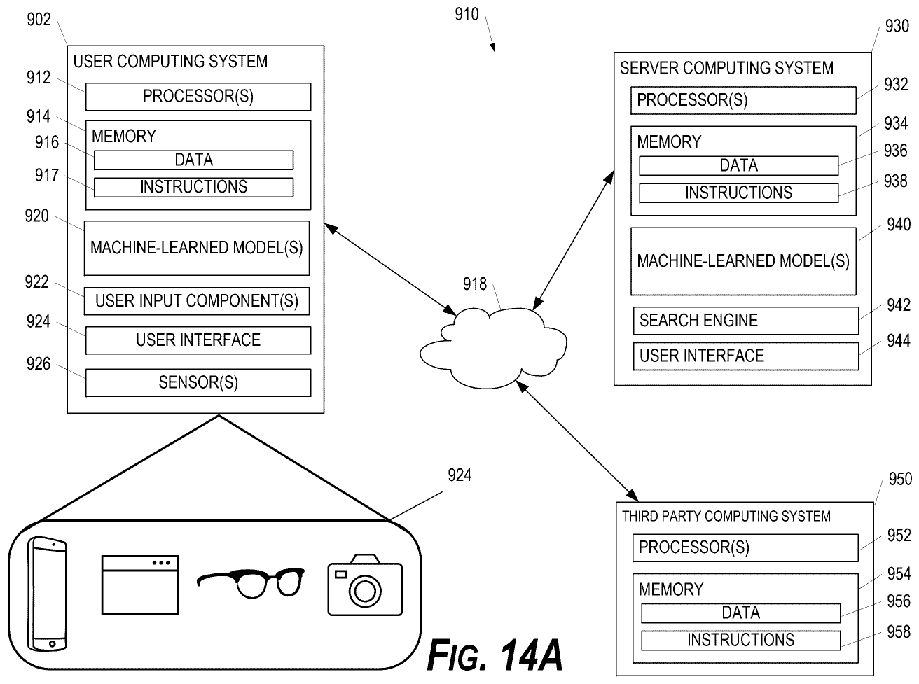

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

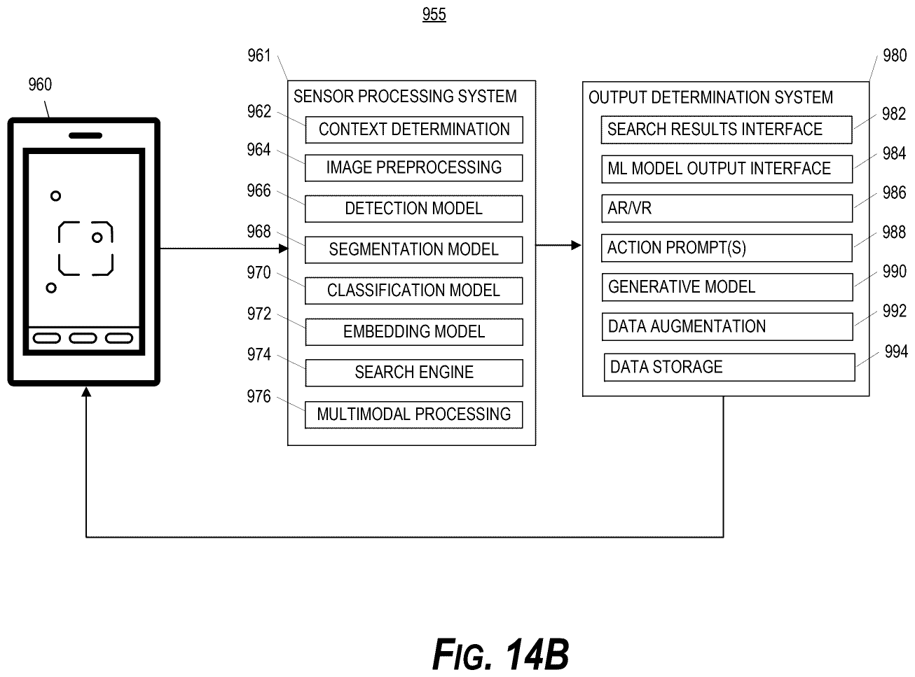

FIG. 14A is a block diagram depicting an example computing system that can be used to process queries according to example embodiments of the present disclosure. The system 910 includes a user computing system 902, a server computing system 930, and/or a third computing system 950 that are communicatively coupled over a network 918. It is noted that aspects of the present disclosure may be implemented by a single system such as a user computing system 902.

The user computing system 902 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 902 includes one or more processors 912 and a memory 914. The one or more processors 912 can be any suitable processing device (e.g., a processor core, a microprocessor, an ASIC, a FPGA, a controller, a microcontroller, etc.) and can be one processor or a plurality of processors that are operatively connected. The memory 914 can include one or more non-transitory computer-readable storage mediums, such as RAM, ROM, EEPROM, EPROM, flash memory devices, magnetic disks, etc., and combinations thereof. The memory 914 can store data 916 and instructions 917 which are executed by the processor 912 to cause the user computing system 902 to perform operations.

Computing system 902 can include a first computing environment that is configured for core operations, processing and memory functions and a second computing environment that is configured for less computationally expensive operations in order to save processing, memory, and battery life. The first computing environment may be referred to as a core computing environment and the second computing environment may be referred to as an always-on computing environment. An always-on computing environment is often provided for computing tasks that are performed anytime the device is powered-on. For example, when a device is not actively being used, an always-on computing environment can be used to sense movements or initial inputs that can trigger other applications and processing by the core computing environment.

In some implementations, the user computing system 902 can store or include one or more machine-learned models 920. For example, the machine-learned models 920 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 920 can be received from the server computing system 930 over network 918, stored in the user computing device memory 914, and then used or otherwise implemented by the one or more processors 912. In some implementations, the user computing system 902 can implement multiple parallel instances of a single machine-learned model 920 (e.g., to perform parallel machine-learned model processing across multiple instances of input data and/or detected features).

More particularly, the one or more machine-learned models 920 may include one or more sequence processing models, one or more detection models, one or more classification models, one or more segmentation models, one or more augmentation models, one or more generative models, one or more natural language processing models, one or more optical character recognition models, and/or one or more other machine-learned models. The one or more machine-learned models 920 can include one or more transformer models. The one or more machine-learned models 920 may include one or more neural radiance field models, one or more diffusion models, and/or one or more autoregressive language models.

The one or more machine-learned models 920 may be utilized to process user queries. The models can also be used to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 20 can process image data, text data, audio data, and/or latent encoding data to generate output data that can include image data, text data, audio data, and/or latent encoding data. The one or more machine-learned models 20 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally or alternatively, one or more machine-learned models 40 can be included in or otherwise stored and implemented by the server computing system 30 that communicates with the user computing system 902 according to a client-server relationship. For example, the machine-learned models 940 can be implemented by the server computing system 930 as a portion of a web service (e.g., a viewfinder service, a visual search service, an image processing service, an ambient computing service, and/or an overlay application service). Thus, one or more models 920 can be stored and implemented at the user computing system 902 and/or one or more models 940 can be stored and implemented at the server computing system 930.

The user computing system 902 can also include one or more user input components 922 that receive user input. For example, the user input component 922 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 924, which may be associated with one or more applications. The one or more user interfaces 924 can be configured to receive inputs and/or provide data for display (e.g., image data, text data, audio data, one or more user interface elements, an augmented-reality experience, a virtual reality experience, and/or other data for display). The user interfaces 924 may be associated with one or more other computing systems (e.g., server computing system 930 and/or third party computing system 950). The user interfaces 924 can include a viewfinder interface, a search interface, a generative model interface, a social media interface, and/or a media content gallery interface.

The user computing system 902 may include and/or receive data from one or more sensors 926. The one or more sensors 926 may be housed in a housing component that houses the one or more processors 912, the memory 914, and/or one or more hardware components, which may store, and/or cause to perform, one or more software packets. The one or more sensors 926 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 902 may include, and/or pe part of, a user computing device 904. The user computing device 904 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 904. For example, a camera of a smartphone may be utilized to capture image data descriptive of the environment, and/or an overlay application of the user computing device 904 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 930 includes one or more processors 932 and a memory 934. The one or more processors 932 can be any suitable processing device (e.g., a processor core, a microprocessor, an ASIC, a FPGA, a controller, a microcontroller, etc.) and can be one processor or a plurality of processors that are operatively connected. The memory 934 can include one or more non-transitory computer-readable storage mediums, such as RAM, ROM, EEPROM, EPROM, flash memory devices, magnetic disks, etc., and combinations thereof. The memory 934 can store data 936 and instructions 938 which are executed by the processor 932 to cause the server computing system 390 to perform operations.

In some implementations, the server computing system 930 includes or is otherwise implemented by one or more server computing devices. In instances in which the server computing system 930 includes plural server computing devices, such server computing devices can operate according to sequential computing architectures, parallel computing architectures, or some combination thereof.

As described above, the server computing system 930 can store or otherwise include one or more machine-learned models 940. For example, the models 940 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 940 are discussed with reference to FIG. 12B.

Additionally and/or alternatively, the server computing system 930 can include and/or be communicatively connected with a search engine 942 that may be utilized to crawl one or more databases (and/or resources). A search/assistant platform may include a search engine in example embodiments. The search engine 942 can process data from the user computing system 902, the server computing system 930, and/or the third party computing system 950 to determine one or more search results associated with the input data. The search engine 492 may perform term based search, label based search, Boolean based searches, image search, embedding based search (e.g., nearest neighbor search), multimodal search, and/or one or more other search techniques.

The server computing system 930 may store and/or provide one or more user interfaces 944 for obtaining input data and/or providing output data to one or more users. The one or more user interfaces 944 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 902 and/or the server computing system 30 can train the models 20 and/or 40 via interaction with the third party computing system 50 that is communicatively coupled over the network 918. The third party computing system 50 can be separate from the server computing system 930 or can be a portion of the server computing system 930. Alternatively and/or additionally, the third party computing system 50 may be associated with one or more web resources, one or more web platforms, one or more other users, and/or one or more contexts.

The third party computing system 950 can include one or more processors 952 and a memory 954. The one or more processors 952 can be any suitable processing device (e.g., a processor core, a microprocessor, an ASIC, a FPGA, a controller, a microcontroller, etc.) and can be one processor or a plurality of processors that are operatively connected. The memory 54 can include one or more non-transitory computer-readable storage mediums, such as RAM, ROM, EEPROM, EPROM, flash memory devices, magnetic disks, etc., and combinations thereof. The memory 954 can store data 956 and instructions 958 which are executed by the processor 952 to cause the third party computing system 950 to perform operations. In some implementations, the third party computing system 950 includes or is otherwise implemented by one or more server computing devices.

The network 918 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 902 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 10.

The central intelligence layer can communicate with a central device data layer. The central device data layer can be a centralized repository of data for the computing system. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 14B is a block diagram depicting an example computing system that performs query processing according to example embodiments of the present disclosure. In particular, the example computing system 50 can include one or more computing devices 60 that can be utilized to obtain, and/or generate, one or more datasets that can be processed by a sensor processing system 61 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 960 (e.g., one or more sensors in the computing device 60). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 960 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 961. The sensor processing system 961 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 962, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 61 may include an image preprocessing block 64. The image preprocessing block 64 may be utilized to adjust one or more values of an obtained and/or received image to prepare the image to be processed by one or more machine-learned models and/or one or more search engines 974. The image preprocessing block 964 may resize the image, adjust saturation values, adjust resolution, strip and/or add metadata, and/or perform one or more other operations.

In some implementations, the sensor processing system 961 can include one or more machine-learned models, which may include a detection model 966, a segmentation model 68, a classification model 970, an embedding model 972, and/or one or more other machine-learned models. For example, the sensor processing system 61 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 968 can be utilized to segment one or more portions of the dataset from the one or more datasets. For example, the one or more segmentation models 968 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 970 can be utilized to process image data, text data, audio data, latent encoding data, multimodal data, and/or other data to generate one or more classifications. The one or more classification models 970 can include one or more image classification models, one or more object classification models, one or more text classification models, one or more audio classification models, and/or one or more other classification models. The one or more classification models 970 can process data to determine one or more classifications.

In some implementations, data may be processed with one or more embedding models 972 to generate one or more embeddings. For example, one or more images can be processed with the one or more embedding models 972 to generate one or more image embeddings in an embedding space. The one or more image embeddings may be associated with one or more image features of the one or more images. In some implementations, the one or more embedding models 972 may be configured to process multimodal data to generate multimodal embeddings. The one or more embeddings can be utilized for classification, search, and/or learning embedding space distributions.

The sensor processing system 961 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 974 may perform feature matching, text based search, embedding based search (e.g., k-nearest neighbor search), metadata based search, multimodal search, web resource search, image search, text search, and/or application search.

Additionally and/or alternatively, the sensor processing system 961 may include one or more multimodal processing blocks 976, which can be utilized to aid in the processing of multimodal data. The one or more multimodal processing blocks 976 may include generating a multimodal query and/or a multimodal embedding to be processed by one or more machine-learned models and/or one or more search engines 974.

The output(s) of the sensor processing system 961 can then be processed with an output determination system 80 to determine one or more outputs to provide to a user. The output determination system 80 may include heuristic based determinations, machine-learned model based determinations, user selection based determinations, and/or context based determinations.

The output determination system 980 may determine how and/or where to provide the one or more search results in a search results interface 982. Additionally and/or alternatively, the output determination system 980 may determine how and/or where to provide the one or more machine-learned model outputs in a machine-learned model output interface 984. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 961 may be utilized to generate and/or provide an augmented-reality experience and/or a virtual-reality experience 986. For example, the one or more obtained datasets may be processed to generate one or more augmented-reality rendering assets and/or one or more virtual-reality rendering assets, which can then be utilized to provide an augmented-reality experience and/or a virtual-reality experience 986 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 988 may be determined based on the output(s) of the sensor processing system 961. For example, a search prompt, a purchase prompt, a generate prompt, a reservation prompt, a call prompt, a redirect prompt, and/or one or more other prompts may be determined to be associated with the output(s) of the sensor processing system 961. The one or more action prompts 988 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 961 may be processed with one or more generative models 990 to generate a model-generated content item that can then be provided to a user. The generation may be prompted based on a user selection and/or may be automatically performed (e.g., automatically performed based on one or more conditions, which may be associated with a threshold amount of search results not being identified).

The output determination system 980 may process the one or more datasets and/or the output(s) of the sensor processing system 961 with a data augmentation block 992 to generate augmented data. For example, one or more images can be processed with the data augmentation block 992 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 961 may be stored based on a data storage block 994 determination.

The output(s) of the output determination system 980 can then be provided to a user via one or more output components of the user computing device 960. For example, one or more user interface elements associated with the one or more outputs can be provided for display via a visual display of the user computing device 960.

The processes may be performed iteratively and/or continuously. One or more user inputs to the provided user interface elements may condition and/or affect successive processing loops.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising, by a computing system comprising one or more computing devices:
obtaining sensor data generated by one or more ambient sensors;
generating tokenized sensor data for at least one embedding space of a machine-learned sequence processing model; and
generating, with the machine-learned sequence processing model, a contextualized query result based on at least one query and the tokenized sensor data.

2. The computer-implemented method of claim 1, wherein:
the computing system comprises a computing device having an always on computing environment and a core computing environment;
the one or more tokens include a plurality of tokens generated over a period of time;
generating tokenized sensor data for at least one embedding space of a machine-learned sequence processing model comprises generating the tokenized sensor data with the always on computing environment;
the method further comprises:
storing the tokenized sensor data in memory of the always on computing environment;
obtaining the at least one query;
providing the tokenized sensor data from the always on computing environment to the core computing environment in response to obtaining the at least one query; and
generating tokenized sensor data for at least one embedding space of the machine-learned sequence processing model comprises processing the one or more tokens with the machine-learned sequence processing model at the core compute environment.

3. The computer-implemented method of claim 1, wherein:
the sensor data includes first sensor data from a first ambient sensor of a first sensor type and second sensor data from a second ambient sensor of a second sensor type;
generating tokenized sensor data for at least one embedding space of the machine-learned sequence processing model, comprises:
generating, with a first machine-learned tokenizer configured to tokenize data of the first sensor type, at least a first token for the at least one embedding space based on the first sensor data; and
generating, with a second machine-learned tokenizer configured to tokenize data of the second sensor type, at least a second token for the at least one embedding space based on the second sensor data.

4. The computer-implemented method of claim 1, wherein:
the sensor data includes first sensor data from a first sensor of a first sensor type and second sensor data from a second sensor of a second sensor type;
generating tokenized sensor data for at least one embedding space of the machine-learned sequence processing model, comprises:
generating, with a machine-learned tokenizer, at least a first token for the at least one embedding space based on the first sensor data; and
generating, with the machine-learned tokenizer, at least a second token for the at least one embedding space based on the second sensor data.

5. The computer-implemented method of claim 1, further comprising:
processing the sensor data with a machine-learned model to generate one or more textual representations of the sensor data;
wherein generating tokenized sensor data for at least one embedding space of the machine-learned sequence processing model, comprises:
embedding the one or more textual representations of the sensor data in the at least one embedding space for the machine-learned sequence processing model.

6. The computer-implemented method of claim 1, wherein:
the tokenized sensor data includes one or more sensor data tokens; and
the method further comprises providing the at least one query and the one or more sensor data tokens to the machine-learned sequence processing model.

7. The computer-implemented method of claim 6, wherein generating, with the machine-learned sequence processing model, the contextualized query result, comprises:
processing the at least one query and the one or more sensor data tokens with the machine-learned sequence processing model.

8. The computer-implemented method of claim 1, wherein:
the tokenized sensor data includes one or more token embeddings;
the method further comprises:
generating one or more sensor data tokens;
generating the one or more token embeddings by embedding the one or more sensor data tokens in an embedding space of the machine-learned sequence processing model.

9. The computer-implemented method of claim 8, further comprising:
providing the at least one query and at the one or more token embeddings to the machine-learned sequence processing model.

10. The computer-implemented method of claim 9, wherein generating, with the machine-learned sequence processing model, the contextualized query result, comprises:
processing the at least one query and the one or more token embeddings with the machine-learned sequence processing model.

11. The computer-implemented method of claim 8, wherein:
the at least one embedding space is a textual embedding space.

12. The computer-implemented method of claim 1, wherein:
the at least one query is a text query.

13. A computing system, comprising:
one or more processors; and
one or more non-transitory computer-readable media that collectively store instructions that, when executed by the one or more processors, cause the one or more processors to perform operations, comprising:
obtaining sensor data generated by one or more ambient sensors;
generating tokenized sensor data for at least one embedding space of a machine-learned sequence processing model; and
generating, with the machine-learned sequence processing model, a contextualized query result based on at least one query and the tokenized sensor data.

14. The computing system of claim 13, wherein:
the computing system includes an always on computing environment including at least a first processor of the one or more processors and a core computing environment including at least a second processor of the one or more processors;
the one or more tokens include a plurality of tokens generated over a period of time;
generating tokenized sensor data for at least one embedding space of a machine-learned sequence processing model comprises generating the tokenized sensor data with the first processor of the always on computing environment;
the operations further comprise:
storing the tokenized sensor data in memory of the always on computing environment;
obtaining the at least one query;
providing the tokenized sensor data from the always on computing environment to the core computing environment in response to obtaining the at least one query; and
generating tokenized sensor data for at least one embedding space of the machine-learned sequence processing model comprises processing the one or more tokens with the machine-learned sequence processing model by the second processor of the core compute environment.

15. The computing system of claim 13, wherein the operations further comprise:
processing the sensor data with a machine-learned model to generate one or more textual representations of the sensor data;
wherein generating tokenized sensor data for at least one embedding space of the machine-learned sequence processing model, comprises:
embedding the one or more textual representations of the sensor data in the at least one embedding space for the machine-learned sequence processing model.

16. The computing system of claim 13, wherein:
the tokenized sensor data includes one or more token embeddings;
the operations further comprise:
generating one or more sensor data tokens;
generating the one or more token embeddings by embedding the one or more sensor data tokens in an embedding space of the machine-learned sequence processing model.

17. One or more non-transitory computer-readable storage media that store instructions that, when executed by one or more processors, cause the one or more processors to perform operations, the operations comprising:
obtaining sensor data generated by one or more ambient sensors;
generating tokenized sensor data for at least one embedding space of a machine-learned sequence processing model; and
generating, with the machine-learned sequence processing model, a contextualized query result based on at least one query and the tokenized sensor data.

18. The one or more non-transitory computer-readable storage media of claim 17, wherein:
the one or more processors implement an always on computing environment and a core computing environment;
the one or more tokens include a plurality of tokens generated over a period of time;
generating tokenized sensor data for at least one embedding space of a machine-learned sequence processing model comprises generating the tokenized sensor data with the first processor of the always on computing environment;
the operations further comprise:
storing the tokenized sensor data in memory of the always on computing environment;
obtaining the at least one query;
providing the tokenized sensor data from the always on computing environment to the core computing environment in response to obtaining the at least one query; and
generating tokenized sensor data for at least one embedding space of the machine-learned sequence processing model comprises processing the one or more tokens with the machine-learned sequence processing model at the core compute environment.

19. The one or more non-transitory computer-readable storage media of claim 17, wherein the operations further comprise:
processing the sensor data with a machine-learned model to generate one or more textual representations of the sensor data;
wherein generating tokenized sensor data for at least one embedding space of the machine-learned sequence processing model, comprises:
embedding the one or more textual representations of the sensor data in the at least one embedding space for the machine-learned sequence processing model.

20. The one or more non-transitory computer-readable storage media of claim 17, wherein:
the tokenized sensor data includes one or more token embeddings;
the operations further comprise:
generating one or more sensor data tokens;
generating the one or more token embeddings by embedding the one or more sensor data tokens in an embedding space of the machine-learned sequence processing model.
